(19) United States
(12) Patent Application Publication
(10) Pub. No.: US 2011/0100396 A1
(43) Pub. Date: May 5, 2011

(54) EQUIPMENT AND METHOD FOR WASHING A CARPET

(75) Inventors: Risto Kunnas, Masala (FI); Arvo Lahtinen, Vantaa (FI); Kari Matula, Anjalankoski (FI)

(73) Assignee: WEST HEAT RAUMA OY, Masala (FI)

(21) Appl. No.: 12/990,287

(22) PCT Filed: Apr. 29, 2009
(86) PCT No.: PCT/FI09/50337

§ 371 Date: Jan. 7, 2011

(30) Foreign Application Priority Data
Apr. 29, 2008 (FI) 20085385

(51) Int. Cl. B08B 1/00; B08B 3/00

(52) U.S. Cl. 134/6; 134/137

(57) ABSTRACT

Equipment for washing carpet includes in the same frame a conveyor for transferring the carpet between equipment units, a control unit for controlling the operation of the equipment, and at least one washing unit, at least one drying unit located after the washing unit in the transport direction. The conveyor in the equipment is able to transfer the carpet through the equipment units at the same speed, the equipment is used for washing the carpets, the underside of which is substantially made of air impermeable material, the at least one washing unit includes a wet or dry cleaning unit with at least one brush and elements for transferring the carpet, each drying unit has an air blower blowing compressed air onto the carpet, the air blower being able to blow compressed air with a pressure of 2-15 bars onto the carpet's pile side, the blowing pressure being dependent on the carpet type.

The invention relates to equipment for washing a carpet according to the preamble of claim 1.

The invention also relates to a method for washing a carpet according to claim 13.

The known mechanical carpet washing apparatuses usually comprise a wet or dry cleaning apparatus, a water rinsing unit, and a separate drying apparatus. The separate drying apparatus is, for example, a tumble drier. Further, the state of the art also knows carpet washing equipment with a drying unit. In this case the washing step is however performed as dry cleaning, because it is impossible to dry the carpet with known methods to sufficiently low moisture and sufficiently fast.

With the above mentioned state of the art as the starting point, the inventor's objective was to achieve equipment and method for washing a carpet, which can be used both in dry and wet cleaning to wash carpets so that the washing, rinsing and drying of the carpet would be done with the same equipment for achieving such a low moisture content for the washed carpet that it could be taken into use immediately without a separate additional drying step.

A second objective of the invention was to achieve equipment for washing carpets, which can be used continuously, with a non-stop principle, for washing several carpets successively.

The above objectives are achieved with the equipment according to claim 1 and the method according to claim 13.

The equipment of the invention has in the same frame a conveyor for transferring the carpet between the equipment units, a control unit for controlling the operation of the equipment, at least one washing unit and at least one drying unit located after the washing unit/washing units in the transport direction so that the conveyor can transfer the carpet through the units in the equipment at the same speed. In this case, the equipment has at least one washing unit comprising a wet or dry cleaning unit with at least one brush and means for transferring the carpet. The equipment is adapted to wash and dry carpets, the underside of which is essentially made of air impermeable material so that the carpet leaves the drying unit/drying units tack free, in which case each drying unit has an air blower blowing compressed air onto the carpet with a pressure of 2-15 bars, preferably 2-10 bars onto the pile side of the carpet, the blowing pressure depending on the carpet type and/or the carpet's travelling speed at the drying station of the drying unit so that the compressed air jet leaving the air blower head is laminar and exactly parallel, and that the air flow directed from the air blower head to the drying station takes with it a 30 to 40-fold amount of air from its environment before air arrives at the drying station.

In the method of the invention for washing a carpet (M) with the equipment of the invention there are again at least the following steps: the carpet is transferred by the conveyor through the washing and drying units of the equipment at the same speed; the operation of the equipment is controlled by the control unit; the carpet, the underside of which is essentially made of air impermeable material, is brush-washed in the washing unit and the carpet is transferred to the drying unit so that the carpet's essentially air impermeable underside is turned away from the said air blower in the drying station below the drying unit's air blower, and compressed air is blown onto the carpet with a pressure of 2-15 bars, preferably 2-10 bars, and most preferably 2-6 bars, depending on the carpets type and/or transfer speed through the drying station with dependant pressure. In this case the compressed air jet from the air blower head has to be laminar and arranged exactly parallel so that the air flow directed to the drying station from the air blower's blowing head takes with it a 30 to 40-fold amount of air from its environment before air arrives at the drying station so that the amount of blown compressed air further has to be such that the carpet leaves the drying station tack free.

The invention is based on two principal issues. First, the equipment of the invention uses in the drying unit a drying means with which it is possible to remove water and moisture from the carpet's pile side by blowing onto it a large amount (e.g. 10 m³/min) of high pressure air (2-15 bars, preferably 2-10 bars). Secondly, the equipment of the invention is used for washing carpets with air proof underside. The air flow bounces back from the carpet's air proof underside so that the drying unit's moisture-removing effect is further intensified. Thus an apparatus is used as the drying unit, the operation of which is based more on the fast blowing off of water or moisture from the carpet's pile than on the slow evaporation of water by means of external thermal energy, as is the case with respective state-of-the-art equipment. This has the advantage that when carpets with essentially air proof underside are driven through the equipment, the washing, rinsing and drying steps can be performed at the same speed, which is the basic condition for a continuous carpet washing and drying process. The drying unit consists of an apparatus, which preferably uses the so-called coanda principle so that the amount of compressed air blown with the air blower is approximately 1/30- 1/40 of the total amount of air arriving at the carpet. The high pressure, relatively narrow directed air jet sucks secondary additional air from the environment in an amount that is 30-40-fold in relation to the amount of primary compressed air blown from the apparatus, before the entire air mass arrives at the surface of the carpet. Thus the equipment achieves a considerably large amount of blown air with small power consumption of the equipment.

The operation of the drying unit can be intensified further by directing thermal radiation to the carpet at the same time as moisture is removed from it by blowing.

An essentially air proof carpet underside refers to a carpet, which generally lets very little air pass through the underside. Nevertheless, the underside may have places that are less tight than the rest of the underside, such as more worn places which let air through.

A tack free carpet refers in this application to that the carpet can be moved along a hard base, such as plastic or wooden floor without it leaving visible moisture onto the base. In a tack free carpet, the moisture content is at most 10-20 p-%.

The advantage of a fast air drying unit used in the apparatus is that even though the carpet's pile side is brushed in the washing unit below the water surface (wet cleaning), the carpet can be made so dry (tack free) with the said drying unit that it is possible to transfer the carpet through the washing, rinsing and drying units at the same speed. Carpet washing, rinsing and drying can thus be performed continuously for several successive carpets.

In an advantageous embodiment of the invention the drying unit consists of two or several longitudinal air blowers, which are located side by side, transverse to the transport direction of the carpet. The advantage of this kind of a drying unit is that the width of the air jet coming from the blower can be adjusted on the basis of the width of the carpet travelling through the equipment.

In a second advantageous embodiment of the invention the equipment comprises several drying units and/or rinsing units and/or washing units located successively in the transport direction of the carpet. In addition there may be one or several brushes for dry brushing the carpet before the washing unit/washing units counterclockwise to the carpet's transport direction before it arrives at the washing unit/washing units.

In a still another advantageous embodiment of the invention a carpet rinsing station with a rinsing unit has been placed in relation to the wash basin so that rinsing water is transferred from the rinsing station to the wash basin by gravity. This provides the advantage that rinsing water can also be used as carpet's washing water, which reduces the amount of fresh water needed in the water circulation.

In a further advantageous embodiment of the invention the carpet rolling unit is located after the drying unit.

The invention is next illustrated in more detail referring to the schematically shown exemplary description of the equipment of the invention.

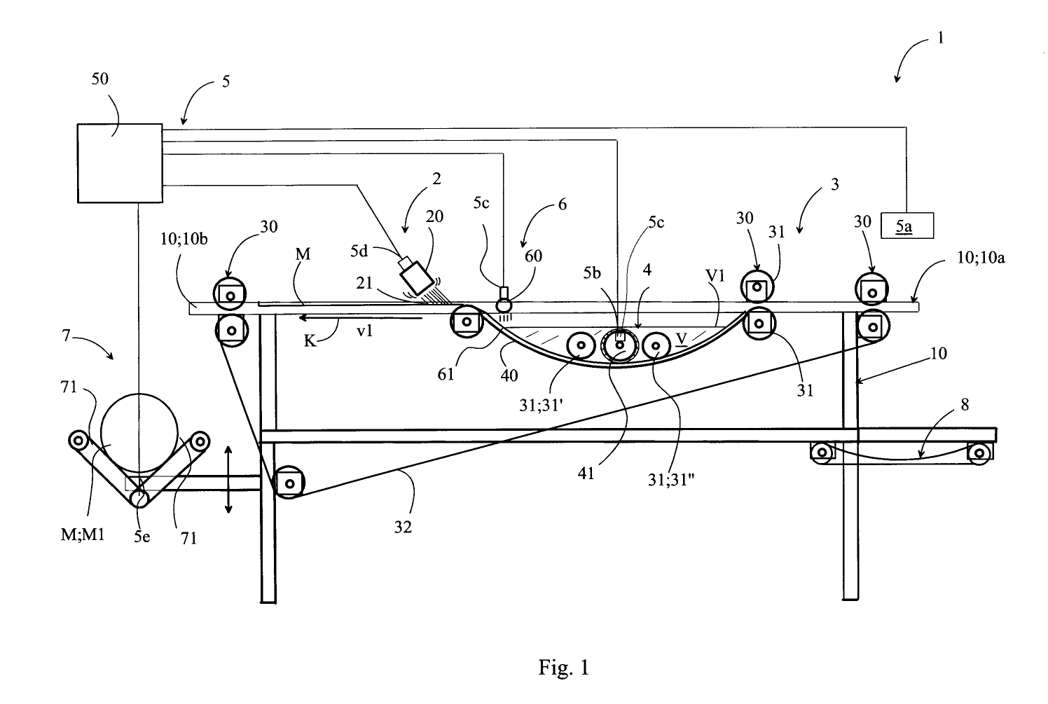

FIG. 1 is a cross-section of the equipment of the invention seen from the side;

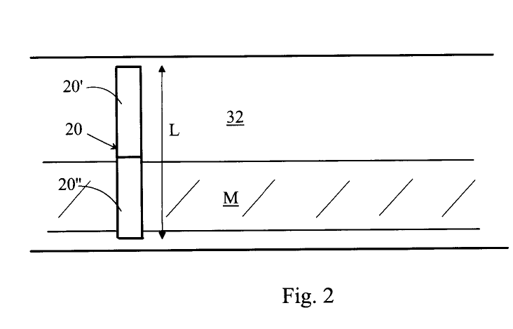

FIG. 2 is a top view of the area of the drying unit in FIG. 1.

The main parts of the equipment 1 in FIG. 1 are the equipment frame 10, comprising successively in the carpet's travel direction: the wash basin of the washing unit 4 placed into the frame 10, the rinsing unit 6, the drying unit 2, the rolling unit 7, the feed unit 8, and the conveyor 3 for transporting the carpet M between the said units. The functions of the equipment 1 are monitored and controlled by the control unit 5.

The conveyor 3 is used in the equipment 1 of the invention for transporting and supporting the carpet M during transport. The conveyor consists of a suitable material, such as mesh-structured plastic, of which the endless belt 32 has been made, the width of the belt being approximately identical with the width of the frame 10 and the wash basin in the transverse direction of the equipment. The endless belt 32 is transferred in the roll nip between the support rolls 31 of the support roll pair 30 in the direction of the arrow K from the first end 10a of the frame 10 to the second end 10b of the frame. From the second end 10b of the frame 10 the endless belt is then rotated back to the first end 10a of the frame. In the first end 10a of the frame there is also located the feed unit 8, with which the carpet M is fed onto the belt 32 of the conveyor 3. From the first end 10a the belt is transferred to the vicinity of the bottom of the wash basin 40 and further to the rinsing station 61 on the upper edge of the wash basin and to the drying station 21. From the drying station the endless belt 32 is transferred to the second end 10b of the frame, where the rolling unit 7 is located.

The washing unit 4 consists of the wash basin 40 embedded in the frame 10 and of the brush 41 placed near the wash basin bottom and rotating about its longitudinal axis of rotation, and of two longitudinal cylindrical transport rolls 31; 31′, 31″ located on both sides of the brush and belonging to the conveyor 3. Both the brush 41 and the transport rolls 31 extend in the longitudinal direction from the first longitudinal side of the basin 40 to the second longitudinal side. The longitudinal sides of the basin 40 refer to the basin sides which are parallel with the carpet's transport direction K. The transverse direction of the basin again refers to the carpet's transport direction K in the basin 40 designated by an arrow and, at the same time, to the direction transverse to the longitudinal axis of the equipment frame 10. In FIG. 1 there is drawn the water surface level V1 in the wash basin 40 when carpets M are being washed with the equipment 1. As can be seen from FIG. 1, both the brush 41 and the transport rolls 31; 31′, 31″ are located below the water surface of the basin 40 during the washing process, in which the carpet's M pile side is brushed using the brush 41 rotating in the basin. The washing process can be intensified by feeding detergent to the washing water V and to the carpet M to be washed, for example, through the shaft of the brush 41 and further through the brush part. Detergent can also be fed onto the carpet either before the carpet is placed onto the belt 32 of the conveyor 3 or before the carpet is transferred to the washing unit 4.

Next after the washing unit 4 in the transport direction K of the carpet M indicated with an arrow there is located the rinsing unit 6. The rinsing unit 6 has a longitudinal spraying apparatus 60 which extends from the first longitudinal side of the belt located transverse to the longitudinal direction of the frame 10 and/or the conveyor belt 32 to the second longitudinal side for achieving a water curtain transverse to the transport direction K. Such an apparatus is, for example, a spray bar, the lower part of which is provided with holes, or an apparatus, which consists of successive spray nozzles. Longitudinal sides of the frame 10 or conveyor belt 32 refer to sides, which are parallel with the transport direction K of the carpet M. Rinsing water is fed by the spraying apparatus 60 perpendicularly to the rinsing station 61 located below the said spraying apparatus 60, the carpet M being transferred through the rinsing station at a certain speed. The rinsing station 61 is located in the upper part of the wash basin 40 higher than the washing unit 4, due to which water is transferred from the rinsing station 61 to the washing unit 4 by gravity.

After the rinsing unit 6, in the transport direction K of the carpet M indicated with an arrow, there is located the drying unit 2. The drying unit 2 has a two-part air blower 20 (cf. FIG. 2), consisting of two so-called air knives 20; 20′ and 20; 20″ arranged side by side transverse to the travel direction K of the carpet M, the total length of the air knives in the lateral direction of the equipment frame 10 being the same as the biggest possible width of the carpet M transferred on the endless belt 32. Each air blower 20 is a longitudinal so-called air knife positioned transverse to the carpet's travel direction and blowing high pressure air, using the venturi and coanda phenomena. High pressure air is blown through the head of the air knife 20 as an exactly parallel thin laminar jet to the drying station 21 below the air knife 20. The high pressure air travelling through the air knife head takes with it from the environment an approximately 30 to 40-fold amount of air in relation to the amount of air blown through the head of the air knife 20. The amount of air taken along by the air flow travelling through the head of the air knife 20 is directly dependent on the distance between the air knife head and the carpet M in the drying station 21. Thus, for example, if the distance of the air knife head and the carpet in the drying station 21 is 15 cm, the thickness of the jet is 51 mm when it arrives onto the carpet, but if the distance between the air knife head and the carpet in the drying station 21 is 30 cm, the thickness of the jet is 102 mm. When the carpet M with an air impermeable underside is transferred pile side up through the drying station 21, the water removing effect of the air knife 20 is intensified further, because the air flow blown onto the carpet pile bounces back from the carpet's air proof underside, removing simultaneously more water from the pile. A suitable blowing capacity for compressed air of the air blower 20 is 2-15 bars, and the amount of air blown from the head of the blower 20 is 5-15 m³ per minute. The pressure and amount of blown air is dimensioned on the basis of the type of the carpet M and the carpet's M travel speed through the drying station 21. However, a blowing capacity of 2-10 bars, and more preferably of 2-6 bars is generally used. The intention is to dry the carpet tack free with the drying unit 2, i.e. to a moisture of approximately 1-20 p-%, especially to 10-15 p-% so that the carpet can be transferred through the carpet drying station 2 as quickly as it is transferred through the rinsing and washing units.

In FIG. 1, the rolling unit 7 is seen after the drying unit 2 in the carpet's transport direction K. There the dried carpet M is rolled into a roll M1 and after that the dried and rolled carpet M; M1 is brought down resting on the support arms 71 of the rolling unit 7.

The apparatus 1 of the invention further includes the control unit 5, which is illustrated schematically in FIG. 1. The control unit 5 comprises the data processing apparatus 50, such as a computer, a number of sensors (not shown in the figure) monitoring the status of the units 2, 4, 6, 7 and the conveyor 3, a number of adjusting devices 5a, 5b, 5c, 5d and 5e and programmable logic, which controls the adjusting devices 5a, 5b, 5c, 5d and 5e on the basis of information received from the sensors. Light cells can be mentioned as examples of sensors; they are used for controlling the operation of the conveyor 3 by means of the adjusting device 5a (for example, stopping the conveyor belt 32 as the carpet exits from the equipment and rotating the conveyor belt 32 as the carpet arrives to the conveyor), and the water thermometer of the water basin 40. The control unit 5 can be used for controlling, for example, the following unit functions by means of a suitable unit-specific adjusting device: the washing speed and washing capacity in the wash basin by adjusting the rotation speed of the brush 41; the travel of the carpet by turning the conveyor 3 on and off; the water temperature in the basin 40 by leading warm water to the basin or by heating the water, for example, by means of a heat exchanger, to the primary side of which waste heat is led from the compressor used for generating compressed air needed in the drying unit. Further, the moisture of the carpet M can be adjusted by the control unit 5 after the drying unit 4 by adjusting the speed of the belt 32 of the conveyor 3 and/or the blowing capacity of the blower and the amount of blown air; the water surface V1 level in the basin 40 by opening and closing the valve for grey water going to the water circulation from the basin 40 and the valve for clean water coming to the basin. Further, the control unit 5 can be used for opening and closing the feed of compressed air to the air blower of the drying unit 2. It is also possible to obtain monitoring information from the control unit 5, which can be used when planning the carpet's washing process. These are, among others, the monitoring of the carpet's condition, registration of details in the carpet washing process, and maintenance of a customer file.

The operation of the equipment according to the invention is as follows:

The carpet M is placed pile side up onto the conveyor's endless belt 32 at the first end 10a of the frame plate. The underside of the carpet M against the endless belt 32 is made of air impermeable material. The carpet M is transferred on the belt 32 of the conveyor 3 first through the wash basin 40 in the carpet washing unit 4 at a certain speed v1. In this case, the carpet M is transferred by the conveyor belt 32 below the water surface, under the rotating brush 41 so that its pile side is brushed. When brushing the carpet, the surface V1 for water V in the basin 40 is kept above both the brush 41 and the transport rolls 31; 31′ and 31; 31″ on both sides of the brush so that the carpet M is washed as wet cleaning.

The carpet M is transferred on the endless belt 32 of the conveyor 3 from the washing unit 4 to the rinsing unit 6 on the edge of the basin 40 at the same speed v1 as at which it is transferred through the wash basin 40 in the washing unit 4. In the rinsing unit 6, the carpet M is transferred through the rinsing station 61 below the spraying apparatus 60 generating a water curtain at the speed v1 and water is simultaneously spilled onto it by the spraying apparatus 60. From the rinsing unit 6 the carpet M is transferred further to the drying unit 2 at the speed v1. The air knife 20 used as the air blower 20 of the drying unit 2 is used for blowing compressed air onto the carpet's pile side to the drying station 21 below the air blower. The pressure of the blown compressed air is approximately 5-15 bars, and the volume flow 5-15 m³/min. Upon arrival onto the carpet, the volume flow of this air flow has increased approximately 30-fold in relation to the volume flow travelling through the air knife head, i.e. to approximately 150-450 m³/min, preferably 300 m³/min, when the transport speed of the carpet was 0.5 m/min so that the air flow's effect for removing moisture from the carpet side was considerably big. The amount and pressure of compressed air to be blown depend on the water adhered to the carpet's pile in the washing and rinsing processes, the carpet's type and the carpet's transfer speed v1 in the drying station 21. The further away the air blower 20 is from the carpet's surface, the more additional air is taken along by the compressed air flow leaving from the said air blower so that the width of the air jet increases. The thickness and volume flow of the air jet is thus inversely comparable to the distance between the carpet in the drying station 21 and the blower head of the air blower 20; if it is desired to feed more air onto the carpet moving through the drying station 21, the air blower 20 is taken farther away from the carpet's surface and if again less air is desired to be blown onto the carpet moving through the drying station, the blower is brought nearer to the carpet's surface. In both cases, the amount of air leaving the air knife head was intensified 30-fold per each distance unit.

Thus the carpet M is transferred by the conveyor 3 through the units 4, 6, 2 at the same speed v1, i.e. the carpet travels through washing, rinsing and drying at the same constant speed v1. After drying, the carpet is transferred to the rolling unit 7, in which it is rolled into the roll M1. After rolling the carpet is lowered down and transferred to storage or to the customer.

Above there have been shown only some advantageous embodiments of the invention and it is obvious for one skilled in the art that it is possible to carry out the invention in many other ways within the inventional idea presented in the patent claims.

Thus the (air) blower 20 can be used for blowing also steam or superheated steam in addition to compressed air. In addition to the air blower 20, the drying unit can also include, for example, a hot air blower or heat radiator.

In the embodiment of the invention described above the equipment includes only one washing, rinsing and drying unit. However, the equipment can also comprise several successive washing units or rinsing units or drying units in the transport direction K.

The carpet can be brought onto the belt 32 of the conveyor 3 pile side down in which case it is also brushed pile side down and turned only before the drying unit so that the carpet's pile side is up.

When an apparatus is used as the air blower 20, in which the amount of air leaving the apparatus head is multiplied when arriving onto the carpet's surface, it is possible to exclude the rinsing unit 6, because the air blower 20 blows the dirty water away from the carpet's pile.

The equipment can further comprise a dry brushing unit before the washing unit 6, in which solid matter and relatively big pieces of waste are brushed away from the carpet's pile before the carpet is washed.

1. An equipment (1) for washing a carpet (M) so that the equipment (1) has in the same frame (10) a conveyor (3) for transferring the carpet (M) between equipment units (4, 2), a control unit (5) for controlling the operation of the equipment, at least one washing unit (4) and at least one drying unit (2) located after a washing unit/washing units in the transport direction (K) so that the conveyor (3) is able to transfer the carpet (M) through the equipment units (4, 2) at the same speed, characterised in that
at least one washing unit (4) comprises a wet or dry cleaning unit with at least one brush and means for transferring the carpet (M);
the equipment (1) is adapted to wash and dry carpets (M), the underside of which is made of substantially air impermeable material so that the carpet exits the drying unit/drying units tack free so that
each drying unit (2) has an air blower (20) blowing compressed air onto the carpet, the air blower being able to blow compressed air with a pressure of 2-15 bars, preferably 2-10 bars onto the carpet's pile side, the blowing pressure being dependent on the carpet's type and/or carpet's travel speed at a drying station (21) of the drying unit (2) so that the compressed air jet leaving a head of the air blower (20) is laminar and exactly parallel, and that the air flow directed from the air blower's 20 head to the drying station (21) takes with it a 30 to 40-fold amount of air from the environment before air arrives at the drying station (21).

2. Equipment (1) according to claim 1, characterised in that the thickness of the compressed air jet arriving at the drying station (21) is directly comparable with the distance between the drying station (21) and the blowing head of the air blower (20).

3. Equipment (1) according to claim 1, characterised in that the drying unit (2) is an air blower (20) consisting of one part or several parts and located transverse to the carpet's transport direction (K), the blowing capacity of the blower being most preferably 2-6 bars and the amount of air leaving from the air blower (20) being approximately 5-15 m³/min, preferably approximately 10 m³/min so that the air blowing capacity and the amount of blown air depends on the carpet's moisture, carpet's type and/or carpet's travel speed on the conveyor (3) and the width of the drying unit (2) being such that it extends from one edge to the other in the lateral direction of the carpet (M) transported on the endless belt (32) of the conveyor.

4. Equipment (1) according to claim 1, characterised in that the drying unit (2) consists of two or several longitudinal air blowers (20), which are located side by side in the direction transverse to the carpet's transport direction (K).

5. Equipment (1) according to claim 1, characterised in that it is also possible to use the air blower (20) of the drying unit (2) for blowing also superheated steam onto the carpet (M) transferred on the belt (32) of the conveyor (3).

6. Equipment (1) according to claim 1, characterised in that the washing unit (4) comprises a wash basin (40) with at least one brush (41) arranged inside, and means for transferring the carpet so that at least part of the brush (41) is below the water surface (V1) when the carpet is being washed by transferring it under the rotating brush (41).

7. Equipment (1) according to claim 6, characterised in that the brush(es) 41 in the wash basin (40) can be rotated about their longitudinal axis the said longitudinal axis being transverse to the carpet's travel direction (k) and that the brush(es) 41 are located in the vicinity of the wash basin's bottom so that the bristles extend to the surface of the carpet transported along the basin's bottom and that there are means for transferring the carpet on both sides of the brush/brushes.

8. Equipment (1) according to claim 7, characterised in that the equipment (1) further includes a dry brushing unit (8) before the washing unit (2) and/or a rinsing unit (6) after the washing unit (2), a carpet's (M) rinsing station (61) in the rinsing unit (6) being arranged in relation to the washing unit (4) so that rinsing water travels by gravity from the rinsing station (61) in the rinsing unit (6) to the wash basin (40).

9. Equipment (1) according to claim 8, characterised in that the rinsing station (61) in the rinsing unit (6) is located on the upper edge of the basin (40).

10. Equipment (1) according to claim 1, characterised in that it further includes a process control unit (5) and a carpet's rolling unit (7) so that the control unit (5) comprises at least means for monitoring and adjusting the water surface (V1) in the wash basin of the washing unit (4), and for controlling the on/off functions of the washing unit's brush (41) and the brushing speed, means for adjusting the on/off functions of the conveyor belt (32) of the conveyor (3) and for adjusting the travel speed of said belt (32), means for controlling the operation of the rolling unit (7), means for controlling the operation of the rinsing unit (6), such as means for adjusting the amount of rinsing water, and means for adjusting the blowing capacity of the air blower (2) and the amount of blown air, and for controlling the on/off functions.

11. Equipment (1) according to claim 10, characterised in that the control unit (5) has means for adjusting the rotation speed of the brush (41) and for maintaining the water (V) temperature at a certain temperature in the basin (40).

12. Equipment (1) according to claim 11, characterised in that the control unit (5) has means for adjusting the amount of air blown by the air knife (20) in the drying unit (2) and for adjusting the pressure and/or direction of air to be blown.

13. Method for washing the carpet (M) with the equipment according to claim 1, characterised in that the method has at least the following steps:
the carpet (M) is transferred on the conveyor (3) through the washing and drying units (4, 2) of the equipment at the same speed;
the operation of the equipment is controlled by the control unit (5);
the carpet (M), the underside of which is made of air impermeable material, is washed with a brush in the washing unit (4);
the carpet is transferred to the drying unit (2) so that the carpet's (M) substantially air impermeable underside (M1) has turned away from the said air blower (20) in the drying station (21) below the drying unit's air blower (20), and compressed air is blown onto the carpet with a pressure of 2-15 bars, preferably 2-10 bars, and more preferably 2-6 bars depending on the carpet type and/or transfer speed through the drying station with dependant pressure so that the compressed air jet from the air blower's (20) head is laminar and arranged exactly parallel and that the air flow directed to the drying station (21) from the air blower's (20) head takes with it a 30 to 40-fold amount of air from its environment before air arrives at the drying station (21) so that the amount of compressed air blown has to be such that the carpet leaves the drying station tack free.

14. Method according to claim 13, characterised in that the amount of air leaving from the air blower (20) to the carpet (M) is approximately 5-15 m³/min, preferably approximately 10 m³/min, and the amount of air arriving onto the carpet is approximately 150-450 m³/min, preferably approximately 300 m³/min, the amount of air depending on the carpet type and/or the carpet's transfer speed through the drying station (21).

15. Method according to claim 14, characterised in that moisture is removed from the carpet (M) by blowing air onto the carpet using an apparatus (2), which uses the venturi and coanda phenomena.

16. Method according to claim 13, characterised in that the carpet (M) is washed by transferring it in the vicinity of the bottom of the wash basin (40) in the washing unit (4) by the belt (32) and by brushing the section of the carpet to be transferred which is below the water surface.

17. Method according to claim 13, characterised in that the carpet (M) is rolled after drying.

18. Method according to claim 13, characterised in that the carpet (M) is dried tack free after washing and rinsing, i.e. to a moisture of 10-20 p-%.

19. Method according to claim 13, characterised in that the carpet (M) is transferred at the same speed in the washing unit (4), rinsing unit (5) and drying unit (2) and the possible rolling unit (7).

20. Method according to claim 13, characterised in that the equipment is used for the continuous and successive washing of carpets so that each carpet (M) has a certain transfer speed through the equipment units.
